(19) United States
(12) Patent Application Publication
(10) Pub. No.: US 2017/0330243 A1
(43) Pub. Date: Nov. 16, 2017

(54) BID RECOMMENDATIONS FOR BUDGET CONSTRAINED CAMPAIGNS

(71) Applicant: Google Inc., Mountain View, CA (US)

(72) Inventors: Andrew Fuqua, New York, NY (US); David Vespe, New York, NY (US); Jonathan Ezra Feldman, New York, NY (US)

(73) Assignee: Google Inc., Mountain View, CA (US)

(21) Appl. No.: 14/215,824

(22) Filed: Mar. 17, 2014

(51) Int. Cl. G06Q 30/02

(52) U.S. Cl. CPC G06Q 30/0275

(57) ABSTRACT

Systems, methods, and computer-readable storage media that may be used to provide bid adjustment recommendations for budget-constrained content campaigns are provided. One method includes identifying a content campaign eligible for each of a plurality of auctions that was excluded from at least some of the auctions based on a budget constraint. The method further includes simulating the auctions using one or more adjusted bid values and generating estimated results for the adjusted bid values based on the simulated auctions. The method further includes determining at least one adjusted bid value that is estimated to result in at least one of the following: (1) increased clicks under substantially the same budget constraint; (2) increased clicks at substantially the same total cost; or (3) decreased cost with substantially the same number of clicks. The method further includes providing at least one recommendation to adopt the at least one adjusted bid value.

### BACKGROUND

Content providers who bid to publish content via online content management systems sometimes apply budget constraints to their content campaigns, such that the campaigns have a limited budget that can be spent over a particular timeframe. Budget-constrained campaigns may be throttled, such that items from the campaigns are left out of some auctions for which the campaigns would be otherwise eligible. As a result, budget-constrained campaigns are left out of some auctions in which they may have received a click at a lower price, and may use up the available budget on less clicks. Content providers are not often aware of this, and they often miss out on “free” clicks.

### SUMMARY

One illustrative implementation of the disclosure relates to a method that includes identifying, at a computerized analysis system, a content campaign eligible for each of a plurality of auctions that was excluded from at least some of the plurality of auctions based on a budget constraint. The method further includes simulating, using the analysis system, the plurality of auctions using one or more adjusted bid values and generating, using the analysis system, estimated results for the one or more adjusted bid values based on the simulated auctions. The method further includes determining, using the analysis system, at least one adjusted bid value of the one or more adjusted bid values based on the estimated results that is estimated to result in at least one of the following: (1) an increased number of estimated clicks as compared to an actual number of clicks resulting from the plurality of auctions, under substantially the same budget constraint; (2) an increased number of estimated clicks as compared to the actual number of clicks resulting from the plurality of auctions, at an estimated total cost over the simulated auctions substantially the same as an actual total cost over the plurality of auctions; or (3) a decreased total estimated cost as compared to the actual total cost, with an estimated number of clicks substantially the same as the actual number of clicks resulting from the plurality of auctions. The method further includes providing at least one recommendation to adopt the at least one adjusted bid value.

Another implementation relates to a system that includes at least one computing device operably coupled to at least one memory and configured to identify a content campaign eligible for each of a plurality of auctions that was excluded from at least some of the plurality of auctions based on a budget constraint. The at least one computing device is further configured to simulate the plurality of auctions using one or more adjusted bid values and generate estimated results for the one or more adjusted bid values based on the simulated auctions. The at least one computing device is further configured to determine at least one adjusted bid value of the one or more adjusted bid values based on the estimated results that is estimated to result in at least one of the following: (1) an increased number of estimated clicks as compared to an actual number of clicks resulting from the plurality of auctions, under substantially the same budget constraint; (2) an increased number of estimated clicks as compared to the actual number of clicks resulting from the plurality of auctions, at an estimated total cost over the simulated auctions substantially the same as an actual total cost over the plurality of auctions; or (3) a decreased total estimated cost as compared to the actual total cost, with an estimated number of clicks substantially the same as the actual number of clicks resulting from the plurality of auctions. The at least one computing device is further configured to provide at least one recommendation to adopt the at least one adjusted bid value.

Yet another implementation relates to one or more computer-readable storage media having instructions stored thereon that, when executed by at least one processor, cause the at least one processor to perform operations. The operations include identifying a content campaign eligible for each of a plurality of auctions that was excluded from at least some of the plurality of auctions based on a budget constraint. The operations further include simulating the plurality of auctions using one or more adjusted bid values and generating estimated results for the one or more adjusted bid values based on the simulated auctions. The operations further include determining at least one adjusted bid value of the one or more adjusted bid values based on the estimated results that is estimated to result in at least one of the following: (1) an increased number of estimated clicks as compared to an actual number of clicks resulting from the plurality of auctions, under an estimated budget constraint within a threshold budget value of the budget constraint applied to the plurality of auctions; (2) an increased number of estimated clicks as compared to the actual number of clicks resulting from the plurality of auctions, at an estimated total cost over the simulated auctions within a threshold cost value of an actual total cost over the plurality of auctions; or (3) a decreased total estimated cost as compared to the actual total cost, with an estimated number of clicks within a threshold click value of the actual number of clicks resulting from the plurality of auctions. The operations further include providing at least one recommendation to adopt the at least one adjusted bid value.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for providing a bid adjustment recommendation for a budget-constrained content campaign according to an illustrative implementation.

FIG. 3 is an illustration of a user interface providing bid simulation data according to an illustrative implementation.

FIG. 4A is an illustration of a user interface showing simulated results of bid/budget adjustments according to an illustrative implementation.

FIG. 4B is an illustration of another user interface showing simulated results of bid adjustments according to an illustrative implementation.

FIG. 5 is a flume diagram of a process for providing a bid adjustment recommendation for a budget-constrained content campaign according to an illustrative implementation.

FIG. 6 is a block diagram of a computing system according to an illustrative implementation.

### DETAILED DESCRIPTION

Referring generally to the Figures, various illustrative systems and methods are providing bid adjustment recommendations for budget-constrained campaigns (e.g., campaigns having a limited budget that can be spent over a particular timeframe). Budget-constrained campaigns are often throttled to help ensure that the budget is distributed over a budget timeframe, rather than spent early in the timeframe so that the campaign cannot participate in any later auctions. In some implementations, a content management system may be configured to throttle budget-constrained campaigns by leaving the campaigns out of auctions for which they would otherwise be eligible with a probability relating to how much of the budget has already been spent and how much of the budget timeframe is left. Budget-constrained content campaigns often receive more expensive clicks than inexpensive clicks. Because of the budget limitations on such campaigns, the campaigns may receive fewer clicks than they could otherwise have received if the budget was spent on less expensive clicks. For example, under a budget of $10, a content provider may receive 10 clicks for $1/click (e.g., with a bid of $1.25/click), or an advertiser may receive 20 clicks for $0.50/click (e.g., with a bid of $0.55/click).

The systems and methods of the present disclosure may provide content providers with bid adjustment recommendations designed to take better advantage of the content provider's limited budget (e.g., from the standpoint of the number of clicks received). An analysis system may receive auction data for all of the auctions for which the campaign was eligible over a particular timeframe, including those auctions from which the campaign was excluded due to throttling. The system may use the auction data to simulate the auctions and estimate results of the auctions if a bid value associated with the campaign were adjusted (e.g., lowered). The results for the adjusted bid value may include, for example, an estimated number of auctions in which an item of the campaign would have been selected for presentation to the user (e.g., a number of impressions), an estimated number of clicks the campaign would have received, an estimated position (e.g., average position) within a content interface in which impressions of the campaign would have appeared, an estimated total cost over the simulated auctions, and/or other data.

The analysis system may use the estimated result data to determine and present the user with one or more data points and/or recommendations illustrating how one or more bid adjustments may affect the results of the campaign. In some implementations, the data points may be determined in relation to an actual budget-constrained/throttled result from the actual, completed auctions (e.g., an actual amount of clicks received and an actual cost to the content provider). In some implementations, the system may determine a “same budget” data point representative of an estimated increased number of clicks that could be achieved by adopting a lower bid value and maintaining substantially the same budget. In some implementations, determining the “same budget” point may involve determining a lower bid value at which the campaign is subjected to little or no throttling in the simulated auctions, such that the campaign is able to capture auctions in which it may receive inexpensive clicks, rather than be excluded from them due to the throttling. In some implementations, the system may additionally or alternatively determine a “same cost” data point representative of an estimated increased number of clicks that could be achieved by adopting a lower bid value and maintaining a cost substantially the same as the actual cost of the throttled campaign. In some implementations, the system may additionally or alternatively determine a “same clicks” data point indicating an estimated amount of cost savings the content provider may achieve by adopting a lower bid value while achieving substantially the same amount of clicks, at a lower cost-per-click, as received in the throttled auctions. In some implementations, the system may additionally or alternatively determine a “same bid” point representative of an estimated number of clicks that could be achieved by removing the budget constraint from the campaign.

In some implementations, additional data may be presented with some or all of the data points above. For example, the system may determine and present to the user an estimated impression position (e.g., average position) within a content interface presented to users of impressions under the simulated bid values. The user may use this information to determine whether an impression position that would result from a recommended bid adjustment (e.g., a lower position resulting from a lower bid value) would be acceptable to the user.

In some implementations, the system may be configured to apply one or more conditions or filters to the estimated result data before presenting recommendations to the content provider. For example, the system may require that the recommended bid adjustment result in at least a threshold click impact, such as a minimum number of additional clicks or a minimum percentage increase in clicks. In some implementations, the system may require that the suggested bid multiplier (e.g., the fraction by which the bid is recommended to be scaled) be above a minimum value, below a maximum value, and/or within a particular range.

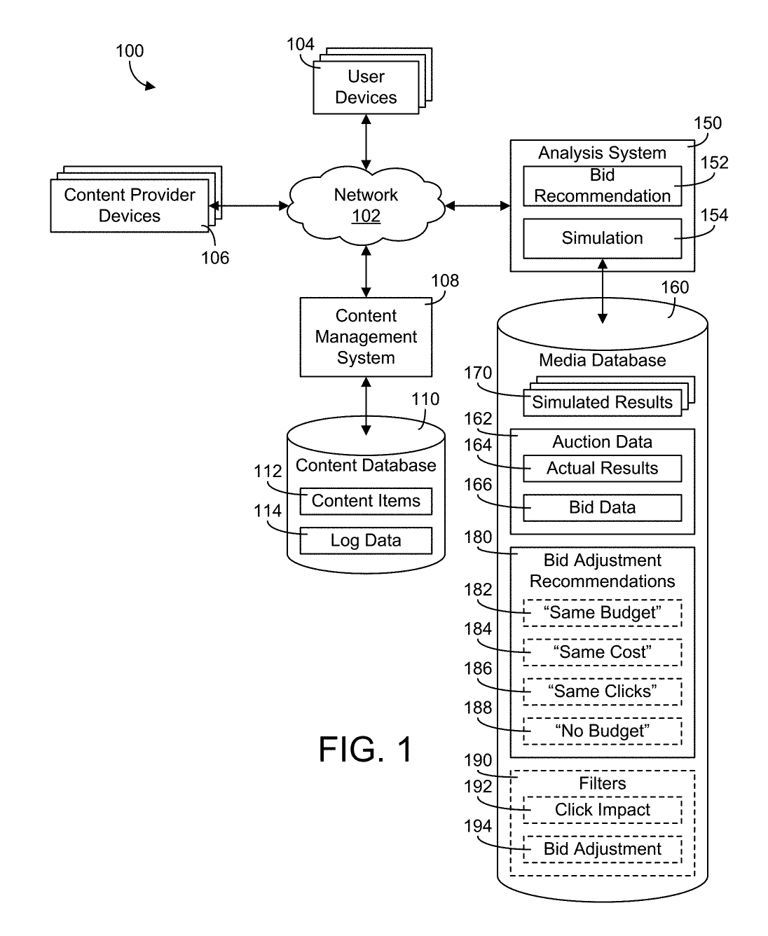

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

One or more content items 112 may be associated with content campaigns that have a budget constraint, such as a maximum daily or weekly budget amount. Content management system 108 may be configured to implement the budget constraint by throttling the campaign across auctions occurring during the budget timeframe to help ensure that the campaign can participate in auctions throughout the timeframe, rather than spending the entire budget early in the timeframe. In some illustrative implementations, content management system 108 may be configured to exclude the campaign from some auctions for which the campaign would otherwise be eligible at a probability based on the amount of budget that has already been spent and/or remains available to spend and the amount of the budget timeframe that remains and/or has already elapsed. In some implementations, this probability may be referred to as a throttling rate. If a large amount of the budget and/or a small amount of the budget timeframe remains, the throttling rate may be low, and the probability that the campaign will be excluded from an auction may be relatively low. If a small amount of the budget and/or a large amount of the timeframe remains, the throttling rate may be high, and the probability that the campaign will be excluded from an auction may be relatively high. In some implementations, a campaign may be considered eligible for an auction if a quality score associated with the campaign and/or content item involved in the auction is above a threshold value (e.g., indicating that the campaign/content item is sufficiently likely to be of interest/relevant to the user if selected). As a result of throttling, a campaign may be excluded from auctions that could have resulted in clicks at a lower cost than may have been paid in other auctions.

Analysis system 150 may be configured to estimate bid adjustments that would allow such budget-constrained campaigns to achieve more clicks and/or a lower cost. Analysis system 150 may simulate the auctions for which a campaign was eligible during a particular time period (e.g., the past week) under one or more adjusted bid values. Analysis system 150 may use the simulations to determine one or more adjusted bid values that are estimated to provide at least one of the following: (1) increased clicks under substantially the same budget; (2) increased clicks for substantially the same cost; and/or (3) substantially the same number of clicks for a decreased cost. Analysis system 150 may provide a recommendation/option to the content provider associated with the content campaign to adopt one or more of the adjusted bids.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other example parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may include a simulation module 154 configured to receive auction data 162 for auctions for which a budget-constrained campaign was eligible, including those from which the campaign was excluded due to throttling. In some implementations, at least some of auction data 162 may be retrieved from log data 114 generated by content management system 108 and stored in content database 110. Simulation module 154 may simulate the auctions under one or more adjusted bids for the campaign using bid data 166 for the auctions (e.g., actual bid values for the competitors in the auctions) and generate simulated results 170 based on the simulated auctions. In some implementations, simulation module 154 may generate simulated results for several different adjusted bid values for the campaign (e.g., a variety of different adjusted bid values).

Analysis system 150 may include a bid recommendation module 152 configured to provide one or more bid adjustment recommendations 180 based on simulated results 170. In some implementations, bid adjustment recommendations 180 may be generated with respect to actual results 164 of the actual auctions. In some such implementations, bid recommendation module 152 may determine one or more adjusted bid values configured to provide an increased number of bids under substantially the same budget and/or for substantially the same cost as the original auctions. In some implementations, bid recommendation module 152 may determine an adjusted bid value configured to provide substantially the same number of clicks at a decreased cost. In various illustrative implementations, various other types of adjusted bid values may be determined and associated recommendations may be provided by bid recommendation module 152.

In various implementations, bid recommendation module 152 and simulation module 154 may be implemented within the same computing device or within different computing devices. In some implementations, simulation module 154 may be implemented within a first computing device, and the first computing device may be configured to generate simulated results 170 and transmit simulated results 170 to bid recommendation module 152 implemented on a second computing device, where bid recommendation module 152 may determine adjusted bids for which to provide recommendations/options. In some implementations, analysis system 150 and content management system 108 may be integrated within a single system (e.g., content management system 108 may be configured to incorporate some or all of the functions/capabilities of analysis system 150).

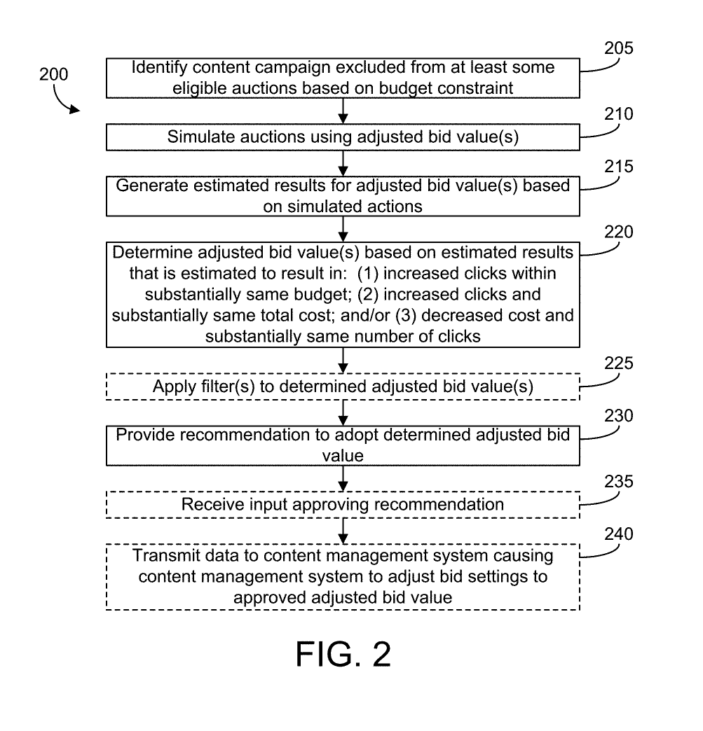

FIG. 2 illustrates a flow diagram of a process 200 for providing a bid adjustment recommendation for a budget-constrained content campaign according to an illustrative implementation. Referring to both FIGS. 1 and 2, analysis system 150 may identify a content campaign that has been “throttled,” or excluded from at least some auctions for which the content campaign was eligible (205). In some implementations, content management system 108 and/or analysis system 150 may be configured to maintain a list of budget-constrained campaigns that have been throttled and/or may include a marker with respect to such campaigns within a database (e.g., database 110 and/or 160).

Analysis system 150 may retrieve auction data 162 for the actual auctions for which the budget-constrained campaign was eligible over a particular time period (e.g., the past day, past week, etc.). In some implementations, analysis system 150 may retrieve auction data 162 for multiple time periods (e.g., two days, two full days and two partial days, one week, etc.) and combine (e.g., average) the data to help reduce the impact of any irregularities in a particular time period (e.g., particular day). Auction data 162 may include data for all of the auctions for which the campaign was eligible, including those auctions from which the campaign was excluded due to the budget constraint associated with the campaign.

Auction data 162 may include bid data 166 indicating the actual bids applied in the completed auctions during the time period (e.g., bids of the content provider and one or more competitors). Auction data 162 may also include actual results 164 indicating one or more outcomes of the auctions, such as where the content provider's bids placed in the auctions, whether the content provider's campaign was excluded from particular auctions due to throttling, a position in which the content provider's impression was displayed within a user interface for auctions in which the content provider's content items are selected for presentation to the user, whether the impression resulted in a click-through by the user, and/or other types of outcome information. In some implementations, actual results 164 may include aggregated results for the time period, such as how many impressions were displayed over the auctions, how many clicks were received over the auctions, average/mean cost per click/impression paid, average/mean position in which impressions were displayed within a content interface presented to users, number of auctions from which campaign was excluded due to throttling over timeframe and/or over portions of the timeframe (e.g., number of auction exclusions in the first hour of the timeframe, second hour, third hour, etc.), etc. The term “click,” as utilized in the present disclosure, includes any manner of selection of a content item by a user, such as touch-based input, voice input, visual input (e.g., from an eye-tracking system), and/or any other type of user input, and is not limited to button clicks or presses.

Analysis system 150 may be configured to simulate the auctions using one or more adjusted bid values (210) and generate estimated results for the adjusted bid values based on the simulated auctions (215). In some implementations, analysis system 150 may be configured to simulate the auctions internally based on auction data 162 using simulation module 154. In some implementations, analysis system 150 may be distributed across multiple devices, and bid recommendation module 152 operating on an analysis device may be configured to transmit a request to simulation module 154 operating on a separate bid simulation device to simulate the auctions for the adjusted bid values and return simulated results 170 to bid recommendation module 152. In some implementations, the request may include at least a portion of auction data 162. In some implementations, the request may include a campaign identifier and/or one or more adjusted bid values, and the bid simulation device may retrieve the auction data to conduct the simulations (e.g., from content management system 108). In some implementations, analysis system 150 may simulate results for one or more predetermined adjusted bid values. In some implementations, analysis system 150 may simulate results for several different adjusted bid values across a range of bid values and generate a “bid landscape” representative of how the results would vary across the range of bid values. In some implementations, analysis system 150 may be configured to extrapolate values between the different simulated bid values.

For a particular adjusted bid value, analysis system 150 may simulate the auctions to estimate outcomes of the auctions if the bid of the content provider had been the adjusted bid value, rather than the bid value actually applied in the conducted auctions. In some implementations, analysis system 150 may simulate each of the auctions for which the campaign was eligible to determine a new simulated result of the auction using the adjusted bid value. In one illustrative implementation, the adjusted bid value may be a lower value than the actual bid applied in the completed auctions. In such an implementation, the adjusted bid value may result in the campaign losing some auctions that it previously won, but may result in the campaign receiving impressions and/or clicks in some auctions at a lower cost than in the actual completed auctions. Analysis system 150 may simulate all of the auctions under a particular adjusted bid value and generate a set of simulated results 170 for the adjusted bid value. Analysis system 150 may repeat the process for additional adjusted bid values. In some implementations, simulated results 170 may include individual data representative of the bid data and/or results for each individual simulated auction. In some implementations, simulated results 170 may additionally or alternatively include aggregated data across the simulated auctions, such as an estimated number of impressions that would have been displayed over the simulated auctions, an estimated number of clicks that would have been received over the simulated auctions, an estimated average/mean cost per click/impression paid, an estimated average/mean position in which impressions would have been displayed within a content interface presented to users, an estimated number of auctions from which campaign would have been excluded due to throttling over the timeframe and/or over portions of the timeframe (e.g., number of auction exclusions in the first hour of the timeframe, second hour, third hour, etc.), etc. In some implementations, simulated results 170 may additionally or alternatively include relative data in relation to the actual results of the completed auctions under the actual bid value associated with the campaign, such as an estimated change in the number of clicks, estimated change in the cost per click/impression paid, estimated change in impression position within a content interface, estimated change in number of auctions from which the campaign was excluded, etc. In some implementations, click data for an adjusted bid value may be generated based on a click model designed to predict an estimated number of clicks that will result from impressions displayed to users. In some implementations, simulated results 170 may be generated for particular pairs of keywords and bids, and the results for the campaign may be generated based on a combination of the keywords for the campaign.

In some implementations, the campaign may be excluded from auctions due to the budget constraint using the same throttling method applied in the actual auctions. This may simulate the effect the adjusted bid value may have on increasing or decreasing a number of auctions from which the campaign would have been excluded due to the budget constraint. In some illustrative implementations, if the adjusted bid value is a lower bid value than the bid actually applied in the completed auctions, this may result in less expensive impressions/clicks early in the budget timeframe, which may reduce the number of auctions from which the campaign is excluded due to the budget constraint.

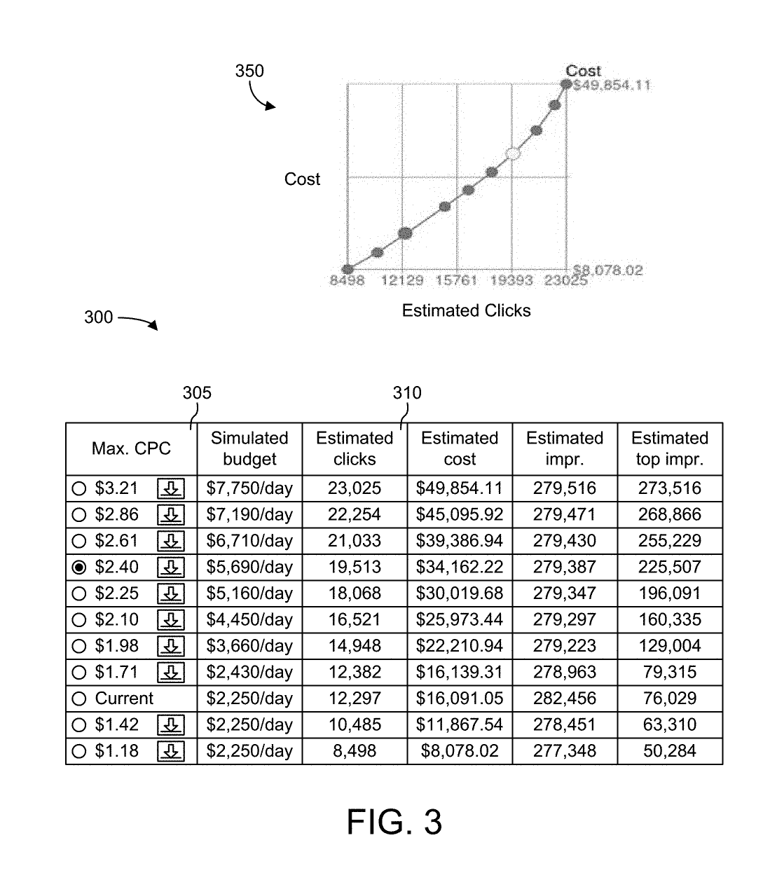

FIG. 3 illustrates a user interface 300 providing bid simulation data according to an illustrative implementation. Interface 300 includes simulated result data 310 corresponding to several different bid values 305. In the illustrated implementation, each bid value 305 is a maximum cost per click (CPC) bid value, or a maximum cost that the content provider is willing to pay for each user selection of a content item impression. Simulated result data 310 includes a simulated budget associated with each bid value (e.g., an estimated budget for the campaign under the bid value without the campaign being throttled), an estimated number of clicks that would be received under the bid value, an estimated total cost over the auctions for the bid value, an estimated number of impressions that would be received under the bid value, and an estimated number of top impressions that would be received under the bid value (e.g., impressions within one or more highest positions within a content interface presented to users). In the illustrated implementation, interface 300 also includes a graph 350 providing a visual illustration of the estimated cost versus the estimated number of clicks for the different bid values 305.

Referring again to FIGS. 1 and 2, analysis system 150 may determine one or more adjusted bid values based on simulated results 170 that are estimated to result in increased clicks and/or decreased cost for the content provider (220). In some implementations, analysis system 150 may determine a “same budget” bid value 182. “Same budget” bid value 182 may be an adjusted bid value under which the campaign is estimated to receive an increased number of clicks under substantially the same budget as was applied in the actual completed auctions. In some implementations, analysis system 150 may determine the simulated budget to be substantially the same as the original budget if the simulated budget is within a threshold budget value (e.g., threshold absolute value or percentage) of the original budget. In some implementations, analysis system 150 may select “same budget” bid value 182 from among the simulated adjusted bid values based on which adjusted bid value is estimated to result in a greatest number of clicks from among the adjusted bid values that have simulated budgets within the threshold value of the original budget. In some implementations, analysis system 150 may select “same budget” bid value 182 based on which adjusted bid value has a simulated budget closest to the original budget. In some implementations, analysis system 150 may select “same budget” bid value 182 based on a combination of the estimated number of clicks and the simulated budget. In some implementations, analysis system 150 may select “same budget” bid value 182 based at least in part on a number of auctions from which the campaign was excluded due to the budget constraint (e.g., prioritizing adjusted bid values resulting in a lower number of auction exclusions).

In some implementations, analysis system 150 may determine a “same cost” bid value 184. “Same cost” bid value 184 may be an adjusted bid value under which the campaign is estimated to receive an increased number of clicks with a simulated total cost substantially the same as the actual total cost over the completed auctions. In some implementations, analysis system 150 may determine the simulated total cost to be substantially the same as the actual cost if the simulated cost is within a threshold cost value (e.g., threshold absolute value or percentage) of the actual cost. In some implementations, analysis system 150 may select “same cost” bid value 184 from among the simulated adjusted bid values based on which adjusted bid value is estimated to result in a greatest number of clicks from among the adjusted bid values that have simulated costs within the threshold value of the actual cost. In some implementations, analysis system 150 may select “same cost” bid value 184 based on which adjusted bid value has a simulated cost closest to the actual cost. In some implementations, analysis system 150 may select “same cost” bid value 184 based on a combination of the estimated number of clicks and the simulated cost. In some implementations, analysis system 150 may select “same cost” bid value 184 based at least in part on a number of auctions from which the campaign was excluded due to the budget constraint (e.g., prioritizing adjusted bid values resulting in a lower number of auction exclusions).

In some implementations, analysis system 150 may determine a “same clicks” bid value 186. “Same clicks” bid value 186 may be an adjusted bid value under which the campaign is estimated to receive substantially the same number of clicks at a lower cost (e.g., a lower total cost and/or lower cost per click) than the completed auctions. In some implementations, analysis system 150 may determine the simulated number of clicks to be substantially the same as the actual number of clicks if the simulated number of clicks is within a threshold value (e.g., threshold absolute number of clicks or percentage of clicks) of the actual number of clicks. In some implementations, analysis system 150 may select “same clicks” bid value 186 from among the simulated adjusted bid values based on which adjusted bid value is estimated to result in a greatest cost reduction from among the adjusted bid values that have simulated clicks within the threshold value of the actual number of clicks. In some implementations, analysis system 150 may select “same clicks” bid value 186 based on which adjusted bid value has a simulated number of clicks closest to the actual number of clicks. In some implementations, analysis system 150 may select “same clicks” bid value 186 based on a combination of the estimated number of clicks and the simulated cost. In some implementations, analysis system 150 may select “same clicks” bid value 186 based at least in part on a number of auctions from which the campaign was excluded due to the budget constraint (e.g., prioritizing adjusted bid values resulting in a lower number of auction exclusions).

In some implementations, analysis system 150 may determine a “no budget” data point 188. “No budget” data point 188 may represent a simulated number of clicks, budget, and/or total cost over the auctions if the campaign was not subject to the budget constraint. Analysis system 150 may determine “no budget” data point 188 by simulating the auctions using the original bid value applied in the actual auctions and including the campaign in all of the auctions for which it is eligible, including those from which the campaign was excluded due to the budget constraint. “No budget” data point 188 may provide the content provider with an estimate of the results that could be obtained by removing the budget constraint from the campaign.

In some implementations, analysis system 150 may be configured to determine one or more adjusted bids that are estimated to result in the campaign not being excluded from any auctions due to the budget constraint. In some illustrative implementations, lowering the bid value may result in less of the budget being used early in the budget timeframe, and if the bid is lowered far enough, the budget may be estimated to be utilized gradually enough that the throttling method may not exclude the campaign from any of the auctions. In some such implementations, analysis system 150 may determine an estimated maximum bid value under which the campaign is included in all auctions for which it is eligible. In some implementations, analysis system 150 may select one or more of the adjusted bid values upon which recommendations may be based from among the bid values that are estimated to result in no throttling.

In some implementations, analysis system 150 may optionally apply one or more filters 190 or conditions to the determined adjusted bid value(s) to determine whether to recommend the adjusted bid value(s) to the content provider (225). The filters may be configured to ensure that the impact of the bid adjustment is significant and/or that the recommended bid adjustment is not too substantial. In some implementations, a click impact filter 192 may be applied to the determined bid values. Click impact filter 192 may exclude determined bid values from being recommended if the estimated number and/or percentage of increased clicks resulting from the adjusted bid value does not exceed a minimum number/percentage. In some implementations, analysis system 150 may apply a cost impact filter (e.g., for “same clicks” bid value 186) that excludes determined bid values from being recommended if the estimated absolute and/or percentage cost reduction does not exceed a minimum number/percentage. In some implementations, analysis system 150 may apply a bid adjustment filter 194 that excludes determined bid values from being recommended if the absolute and/or percentage bid adjustment (e.g., bid scaling factor) is less than a minimum value, more than a maximum value, and/or outside of a scaling factor range. Bid adjustment filter 194 may reduce the likelihood that the content provider will reject the recommendation on the basis that the required bid adjustment is too drastic.

Analysis system 150 may provide one or more bid adjustment options or recommendations 180 to the content provider (230). In some implementations, recommendations 180 may include some or all of simulated results 170. In some such implementations, recommendations 180 may include, for each recommended adjusted bid, an estimated number of clicks and/or impressions, estimated total cost, estimated budget, estimated average/mean position within a content interface, estimated number of auctions from which the campaign would be excluded due to a budget constraint, and/or other data. In various implementations, recommendations 180 may be transmitted to a content provider device 106 of the content provider (e.g., in a file format, such as via an attachment to an email) and/or accessible through an interface accessed by content provider device 106 via network 102 (e.g., an Internet-accessible interface). In some implementations, analysis system 150 may receive input approving a recommendation (235) and may transmit data to content management system 108 configured to cause content management system 108 to adjust current bid settings for the campaign to the approved adjusted bid value associated with the recommendation (240).

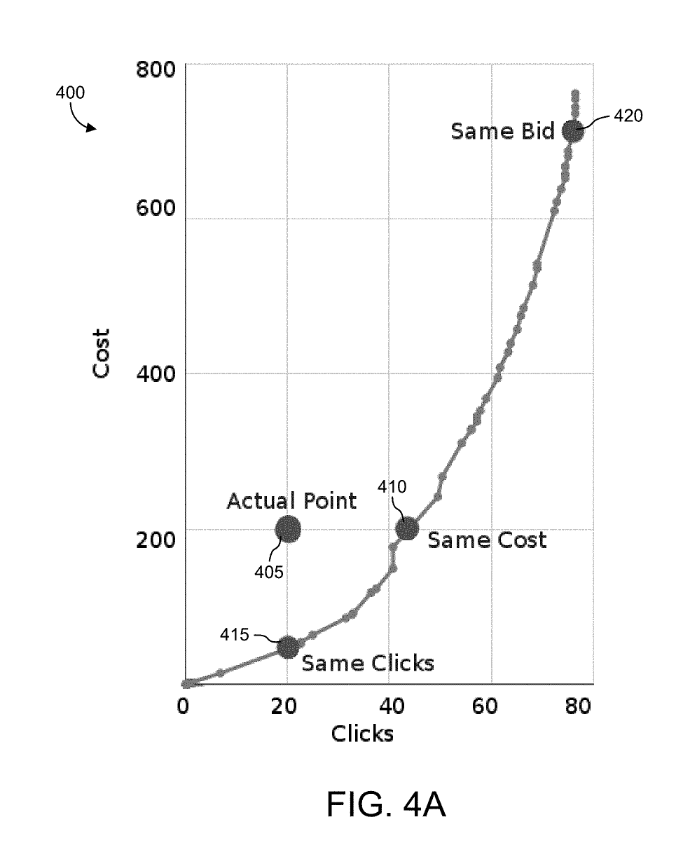

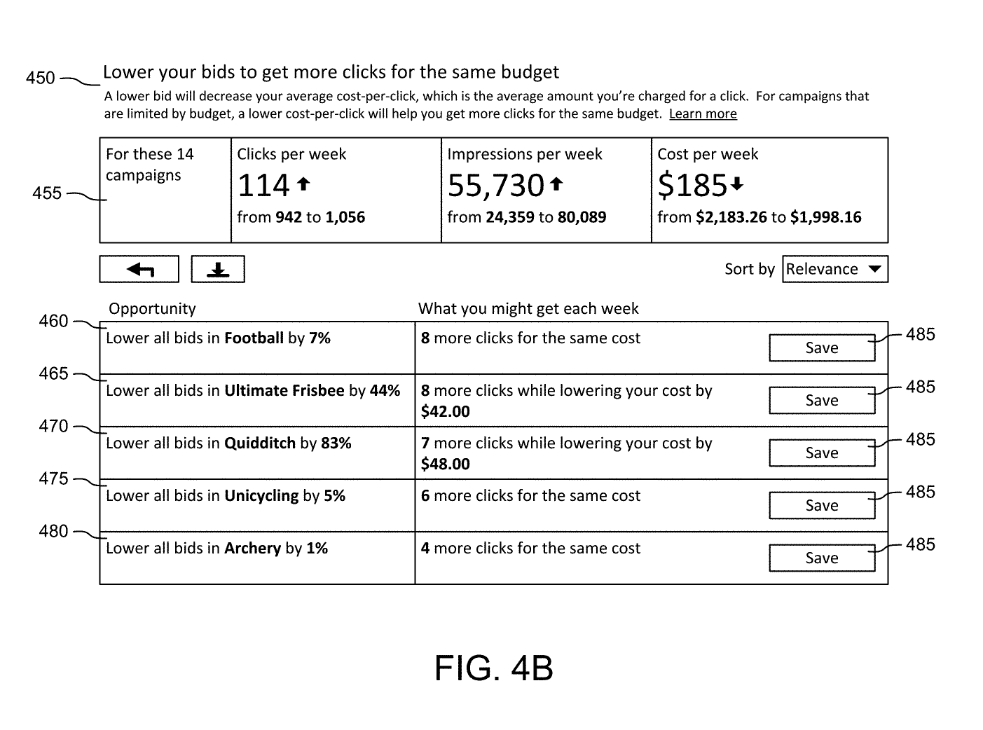

In some implementations, analysis system 150 may be configured to provide bid adjustment options/recommendations via a graphical user interface. FIG. 4A illustrates a user interface 400 showing simulated results of bid/budget adjustments according to an illustrative implementation. In some implementations, an interface similar to interface 400 may be provided to the content provider to communicate the bid adjustment options/recommendations. Interface 400 illustrates a graph plotting an estimated number of clicks against an estimated total cost over a plurality of auctions. The plot shown in interface 400 represents an estimated number of clicks and cost associated with the campaign if the campaign is not throttled (e.g., not excluded from any of the auctions based on the budget constraint). Interface 400 illustrates an actual point 405 showing the number of clicks and cost associated with the completed auctions, where the campaign was excluded from at least some of the auctions due to the budget constraint. Interface 400 also includes a “same cost” point 410 representing an estimated number of clicks that could be achieved if the campaign bid value was lowered to a point where the campaign was not excluded from any auctions and the estimated cost is substantially the same as the actual cost of the completed auctions. Interface 400 also includes a “same clicks” point 415 representing an estimated reduced cost that could be achieved if the campaign bid value was lowered to a point where the campaign was not excluded from any auctions and the estimated number of clicks is substantially the same as the actual number of clicks over the completed auctions. Interface 400 also includes a “same bid” point 420 representing an estimated number of clicks and total cost associated with removing the budget constraint from the campaign.

FIG. 4B illustrates another user interface 450 showing simulated results of bid adjustments according to an illustrative implementation. Interface 450 includes summary information 455 showing an estimated increase in clicks and impressions and/or estimated cost reduction that may be achieved by adopting all of the bid lowering suggestions provided for 14 different campaigns.

Interface 450 also includes individual bid suggestions and estimated result data for each campaign. A first recommendation 460 suggests lowering all bids for a Football campaign by seven percent, for an estimated click increase of eight clicks at substantially the same cost. A second recommendation 465 suggests lowering all bids for an Ultimate Frisbee campaign by 44 percent, for an estimated click increase of eight clicks and estimated cost reduction of $42.00. A third recommendation 470, fourth recommendation 475, and fifth recommendation 480 provide similar suggestions for Quidditch, Unicycling, and Archery campaigns, respectively. The content provider to whom the recommendations are presented may approve one or more of the recommendations by clicking the associated save button 485.

Referring again to FIGS. 1 and 2, in some implementations, analysis system 150 may be configured to choose either “same budget” bid value 182 or “same cost” bid value 184 to recommend to the content provider. In some implementations, analysis system 150 may provide “same cost” bid value 184 rather than “same budget” bid value 184 unless “same cost” bid value 182 is excluded for some reason (e.g., based on filters 190). In other implementations, analysis system 150 may prefer “same budget” bid value 182 over “same cost” bid value 184. In one illustrative implementation, analysis system 150 may utilize an algorithm similar to the following to determine options/recommendations to provide to the content provider:

For each campaign C:

If C is budget-constrained:

If C has a throttled bid landscape:

Find “same budget” bid value 282
Find “same cost” bid value 284
If “same budget” bid value 282 has (a) cost <= actual cost and
(b) “significant impact”

Return “same budget” bid value 282 as suggestion

If “same cost” bid value 284 has (a) budget <= actual budget
and (b) “significant impact”

Return “same cost” bid value 284 as suggestion

Else

Return neither “same budget” bid value 282 nor “same
cost” bid value 284 as suggestion

Where “significant impact” may be defined as:
a) Minimum number of absolute click impact
b) Minimum percentage click impact
c) Bid scaling factor (e.g., bid multiplier) within a min and max range

In various implementations, the types of bid changes that may be simulated and recommended may be one or more of a variety of types of bid changes. In some implementations, analysis system 150 may recommend that the content provider scale one or more bids for a campaign (e.g., keyword-level CPC/CPA/CPM bids) by some amount or percent (e.g., by a bid multiplier). In some implementations, analysis system 150 may recommend that all bids be set to a uniform value or be reduced by a uniform value (e.g., a bid for a “roses” keyword at $1 CPC and a “flower delivery” keyword at $2 CPC may both be lowered by $0.80).

In some implementations, analysis system 150 may determine and recommend a scaling factor for the bids by choosing a bid that leads to a uniform CPC/CPA/CPM across all keywords or a group of keywords. In some implementations, analysis system 150 may recommend that bids across multiple keywords be reduced in a manner to maintain a uniform marginal cost savings (e.g., marginal cost per click equalization), such that the bids are adjusted to eliminate clicks having highest marginal CPC/CPA/CPM values.

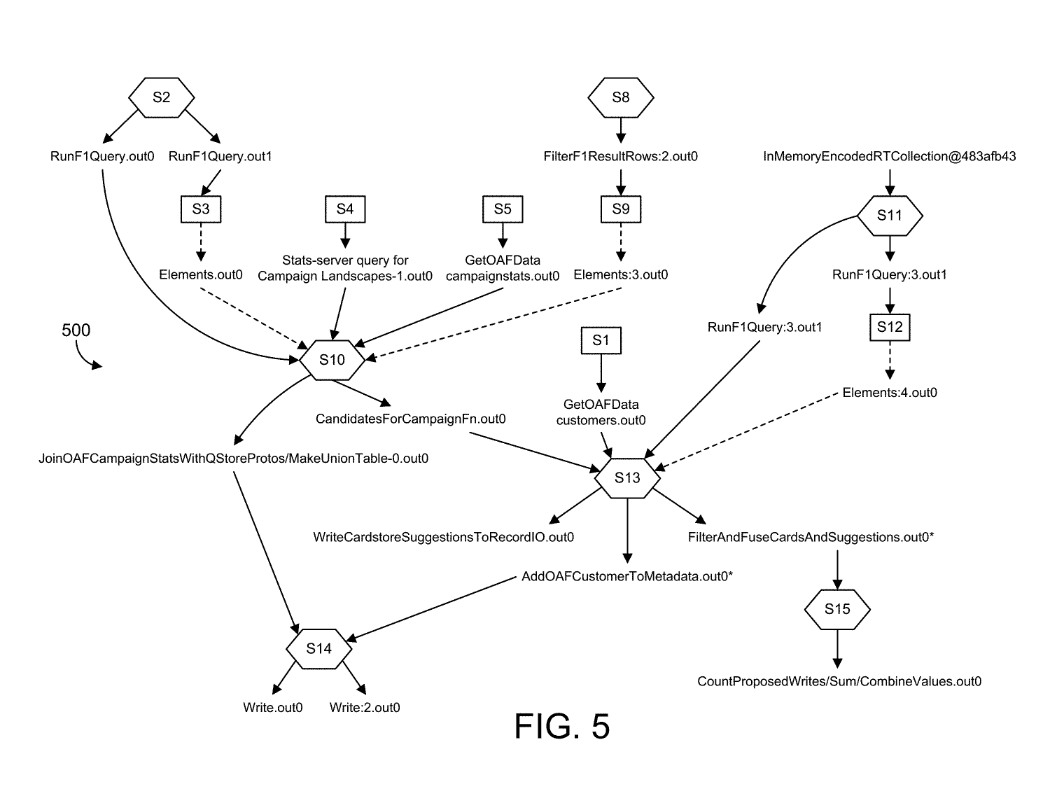

FIG. 5 illustrates a flume diagram 500 of a process for providing a bid adjustment recommendation for a budget-constrained content campaign according to an illustrative implementation. Flume diagram 500 shows one illustrative implementation of a pipeline for performing various operations used to determine adjusted bid values and provide options/recommendations to a content provider. It should be appreciated that other implementations may include additional, fewer, or different operations than are illustrated in flume diagram 500.

Referring now to both FIGS. 1 and 5, at operation 51, analysis system 150 may retrieve one or more metadata items relating to the content provider. In some implementations, the metadata may include, for example, a content provider tier (e.g., based on a spend volume associated with the content provider account), a type of account, a content vertical (e.g., automotive, consumer electronics, etc.), and/or various other types of information.

Analysis system 150 may run one or more queries to gather information for use in filtering out campaigns that should not receive suggestions (e.g., based on content provider preferences). The queries may be run at operations S2 and S8, and intermediate steps associated with compiler operations may be conducted at operations S3 and S9. Analysis system 150 may receive throttled campaign bid landscape data from a statistics server (S4) and auxiliary information about the campaign(s) (e.g., budget amounts) from an analytics framework data source (S5).

Analysis system 150 may utilize the input data to determine the adjusted bid value(s), apply any filters, estimate impacts of the adjusted bid value(s), and/or determine recommendations (S10). Additional input may be received and processed by the compiler (S11 and S12), and the data generated in S10 may be merged with the received metadata for the content provider (S13) and written to memory for later access (S14). In some implementations, the recommendations may be written to a separate memory (S15) from which the suggestions are retrieved by a content provider frontend configured to present the suggestions to the content provider.

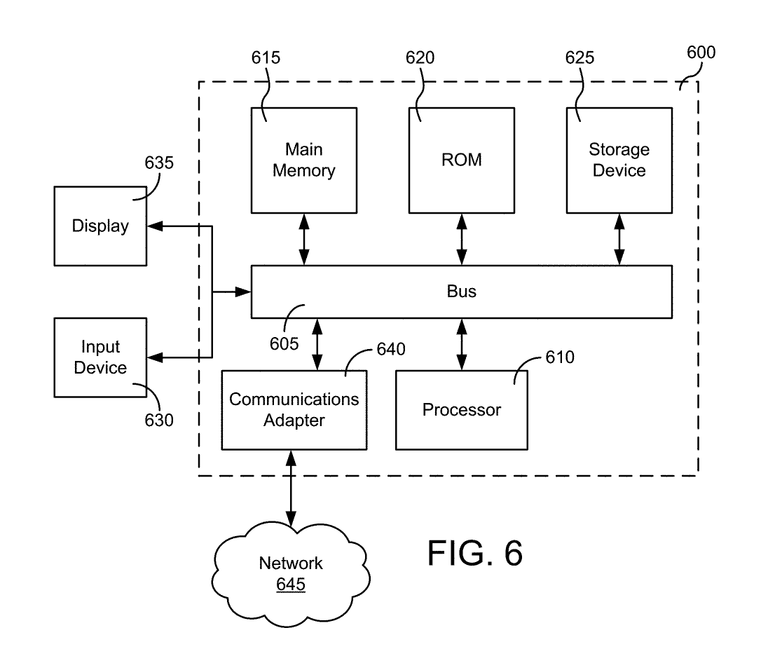

FIG. 6 illustrates a depiction of a computer system 600 that can be used, for example, to implement an illustrative user device 104, an illustrative content management system 108, an illustrative content provider device 106, an illustrative analysis system 150, and/or various other illustrative systems described in the present disclosure. The computing system 600 includes a bus 605 or other communication component for communicating information and a processor 610 coupled to the bus 605 for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

In some implementations, the computing system 600 may include a communications adapter 640, such as a networking adapter. Communications adapter 640 may be coupled to bus 605 and may be configured to enable communications with a computing or communications network 645 and/or other computing systems. In various illustrative implementations, any type of networking configuration may be achieved using communications adapter 640, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

Although an example processing system has been described in FIG. 6, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
retrieving, by an analysis system from a campaign database, historical campaign data related to a content campaign, the historical campaign data including:
a budget constraint;
historical auction data related to a plurality of auctions for which the content campaign was eligible, the plurality of auctions including a first auction and a second auction, wherein the first auction is associated with data indicating that a bid was made and the second auction is associated with data indicating that no bid was made based on the budget constraint, and
historical bid data comprising a bid parameter value;
for each of a plurality of adjustments applied to the bid parameter value, simulating an adjusted campaign by:
initializing a remaining budget value or a cumulative spend value,
initializing a remaining time value or a cumulative time value,
determining, based on the remaining budget value or cumulative spend value and remaining time value or cumulative time value, whether a bid is entered for the first auction,
if a bid is entered for the first auction, determining, based on the adjusted bid parameter value, a revised outcome of the first auction and updating the remaining budget value or cumulative spend value,
updating the remaining time value or a cumulative time value to correspond to the second auction,
determining that a bid is entered for the second auction in the simulation by:
calculating a throttling rate based on the remaining budget value or cumulative spend value and the remaining time value or cumulative time value,
setting a throttling threshold value based on the throttling rate,
selecting a random value, and comparing the throttling threshold value to the random value,
determining, based on the comparison, that a bid is entered for the second auction, determining an outcome of the second auction based on the adjusted bid parameter value,
updating the remaining budget value or a cumulative spend value based on the outcome of the second auction, and
storing the revised outcomes of the auctions in a revised campaign database;
determining, by the analysis system, that one of the adjusted bid parameter values corresponding to one of the simulated campaigns results in at least one of the following:
an increased number of estimated clicks as compared to an historical number of clicks for the content campaign, under substantially the same budget constraint,
an increased number of estimated clicks as compared to an historical number of clicks for the content campaign, at an estimated total cost over the at least one simulated campaign substantially the same as an historical total cost over the content campaign, or
a decreased total estimated cost as compared to an historical total cost, with an estimated number of clicks substantially the same as an historical number of clicks for the content campaign; and
providing at least one recommendation to adopt the at least one adjusted bid parameter value, responsive to the determination.

2. The method of claim 1, wherein determining the results of the at least one simulated content campaign comprises determining that the adjusted bid value results in the increased number of estimated clicks under substantially the same budget constraint.

3. The method of claim 1, wherein determining the results of the at least one simulated content campaign comprises determining that the adjusted bid value results in the increased number of estimated clicks at the estimated total cost over the simulated auctions content campaign substantially the same as the actual historical total cost over the plurality of auctions.

4. The method of claim 1, wherein determining the results of the at least one simulated content campaign comprises determining that the adjusted bid value results in the decreased total estimated cost, with the number of estimated clicks substantially the same as the historical number of clicks for the content campaign.

5. The method of claim 1, further comprising generating an indication of an estimated number of clicks that would be received if the historical bid parameter value were maintained and the budget constraint were removed.

6. (canceled)

7. The method of claim 1, wherein for each auction of the at least one simulated campaign, a bid is entered.

8. The method of claim 1, further comprising applying a click impact filter to determine whether to provide the at least one bid recommendation to a content provider, wherein the click impact filter comprises one or both of a minimum number or a minimum percentage of increased clicks estimated to result from the at least one adjusted bid parameter value.

9. The method of claim 1, further comprising applying a bid adjustment filter to determine whether to provide the at least one bid recommendation to a content provider, wherein the bid adjustment filter comprises at least one of a minimum scaling factor, a maximum scaling factor, or an acceptable scaling factor range for a bid scaling factor associated with the at least one adjusted bid parameter value.

10. (canceled)

11. A system comprising:
at least one computing device operably coupled to at least one memory and configured to:
retrieve, by the processor system from the memory, historical campaign data related to a content campaign, the historical campaign data including:
a budget constraint;
historical auction data related to a plurality of auctions for which the content campaign was eligible, the plurality of auctions including a first auction and a second auction, wherein the first auction is associated with data indicating that a bid was made and the second auction is associated with data indicating that no bid was made based on the budget constraint, and
historical bid data comprising a bid parameter value;
for each of a plurality of adjustments applied to the bid parameter value, simulate an adjusted campaign by:
initializing a remaining budget value or a cumulative spend value,
initializing a remaining time value or a cumulative time value,
determining, based on the remaining budget value or cumulative spend value and remaining time value or cumulative time value, whether a bid is entered for the first auction,
if a bid is entered for the first auction, determining, based on the adjusted bid parameter value, a revised outcome of the first auction and updating the remaining budget value or cumulative spend value,
updating the remaining time value or a cumulative time value to correspond to the second auction,
determining that a bid is entered for the second auction in the simulation by:
calculating a throttling rate based on the remaining budget value or cumulative spend value and the remaining time value or cumulative time value,
setting a throttling threshold value based on the throttling rate,
selecting a random value, and comparing the throttling threshold value to the random value,
determining, based on the comparison, that a bid is entered for the second auction,
determining an outcome of the second auction based on the adjusted bid parameter value,
updating the remaining budget value or a cumulative spend value based on the outcome of the second auction, and
storing the revised outcomes of the auctions in the memory;
determine that at least one of the adjusted bid parameter values corresponding to at least one of the simulated campaigns results in at least one of the following:
an increased number of estimated clicks as compared to an historical number of clicks for the content campaign, under substantially the same budget constraint;
an increased number of estimated clicks as compared to an historical number of clicks for the content campaign, at an estimated total cost over the at least one simulated campaign substantially the same an historical total cost over the content campaign; or
a decreased total estimated cost as compared to an historical total cost, with an estimated number of clicks substantially the same as an historical number of clicks for the content campaign; and
provide at least one recommendation to adopt the at least one adjusted bid parameter value, responsive to the determination.

12. The system of claim 11, wherein the at least one computing device is configured to determine the at least one first adjusted bid parameter value results in the increased number of estimated clicks under substantially the same budget constraint.

13. The system of claim 11, wherein the at least one computing device is configured to determine the at least one first adjusted bid parameter value results in the increased number of estimated clicks at the estimated total cost over the at least one simulated auctions substantially the same as the actual total cost over the plurality of auctions.

14. The system of claim 11, wherein the at least one computing device is configured to determine the least one adjusted bid parameter value results in the decreased total estimated cost as compared to the historical total cost, with the number of estimated clicks substantially the same as the historical number of clicks for the at least one simulated campaign.

15. The system of claim 11, wherein the at least one computing device is configured to generate an indication of an estimated number of clicks that would be received if the historical bid parameter value were maintained and the budget constraint were removed.

16. The system of claim 11, wherein for each auction of the at least one simulated campaign, a bid is entered.

17. One or more computer-readable storage media having instructions stored thereon that, when executed by at least one processor, cause the at least one processor to perform operations comprising:
retrieving, by an analysis system from a campaign database, historical campaign data related to a content campaign, the historical campaign data including:
a budget constraint;
historical auction data related to a plurality of auctions for which the content campaign was eligible, the plurality of auctions including a first auction and a second auction, wherein the first auction is associated with data indicating that a bid was made and the second auction is associated with data indicating that no bid was made based on the budget constraint, and
historical bid data comprising a bid parameter value;
for each of a plurality of adjustments applied to the bid parameter value, simulating an adjusted campaign by:
initializing a remaining budget value or a cumulative spend value,
initializing a remaining time value or a cumulative time value,
determining, based on the remaining budget value or cumulative spend value and remaining time value or cumulative time value, whether a bid is entered for the first auction,
if a bid is entered for the first auction, determining, based on the adjusted bid parameter value, a revised outcome of the first auction and updating the remaining budget value or cumulative spend value,
updating the remaining time value or a cumulative time value to correspond to the second auction,
determining that a bid is entered for the second auction in the simulation by:
calculating a throttling rate based on the remaining budget value or cumulative spend value and the remaining time value or cumulative time value,
setting a throttling threshold value based on the throttling rate,
selecting a random value, and comparing the throttling threshold value to the random value,
determining, based on the comparison, that a bid is entered for the second auction,
determining an outcome of the second auction based on the adjusted bid parameter value,
updating the remaining budget value or a cumulative spend value based on the outcome of the second auction, and
storing the revised outcomes of the auctions in a revised campaign database;
determining that at least one of the adjusted bid parameter values corresponding to at least one of the simulated campaigns results in at least one of the following:
an increased number of estimated clicks as compared to an historical number of clicks for the content campaign, under an estimated budget constraint within a threshold budget value of the budget constraint,
an increased number of estimated clicks as compared to an historical number of clicks for the content campaign, at an estimated total cost over the at least one simulated campaign within a threshold cost value of an historical total cost over the content campaign, or
a decreased total estimated cost as compared to an historical total cost, with an estimated number of clicks within a threshold cost value of an historical number of clicks for the content campaign; and
providing at least one option to adopt the at least one adjusted bid parameter value, responsive to the determination.

18. The one or more computer-readable storage media of claim 17, wherein determining the at least one adjusted bid parameter value comprises determining a first adjusted bid value estimated to result in the increased number of estimated clicks under the estimated budget constraint within the threshold budget value of the budget constraint.

19. The one or more computer-readable storage media of claim 17, wherein determining the at least one adjusted bid parameter value comprises determining a first adjusted bid value estimated to result in the increased number of estimated clicks at the estimated total cost of the simulated campaign within the threshold cost value of an actual total cost over the historical campaign.

20. The one or more computer-readable storage media of claim 17, wherein determining the at least one adjusted bid value comprises determining a first adjusted bid parameter value estimated to result in the decreased total estimated cost as compared to the historical total cost, with the number of estimated clicks within the threshold click value of the historical number of clicks of the content campaign.
